(19) United States
(12) Patent Application Publication
(10) Pub. No.: US 2026/0169432 A1
(43) Pub. Date: Jun. 18, 2026

(54) MANUFACTURING METHOD FOR MECHANICAL RESONATORS

(71) Applicant: Nivarox-FAR S.A., Le Locle (CH)

(72) Inventors: Geoffrey CHASSIN, Morteau (FR); Pierre Cusin, Villars-Burquin (CH)

(73) Assignee: Nivarox-FAR S.A., Le Locle (CH)

(21) Appl. No.: 19/386,789

(22) Filed: Nov. 12, 2025

(30) Foreign Application Priority Data
Dec. 13, 2024 (EP) 24219838.0

(51) Int. Cl. G04B 17/06; G04B 17/04

(52) U.S. Cl. CPC G04B 17/066; G04B 17/045

(57) ABSTRACT

A method for manufacturing a set of mechanical resonators (2a) having structural characteristics with an average value comprised within a predetermined range of values, the method providing for the formation (21), in a plate (1), of mechanical resonators (2b, 2c) and of oscillating members (10a, 10b, 10c) and the calculation (26) of dimensional corrections to be applied to the resonators (2b, 2c) formed based on the value determined for the structural characteristic, and then a modification (28) of the dimensions of the resonators (2b, 2c) formed, based on the dimensional corrections calculated, to obtain the set of resonators (2a) having structural characteristic values comprised within the predetermined range of values.

### CROSS REFERENCE TO RELATED APPLICATION

This application claims priority to European Patent Application No. 24219838.0 filed Dec. 13, 2024, the entire contents of which are incorporated herein by reference.

### TECHNICAL FIELD OF THE INVENTION

The present invention relates to the field of manufacturing mechanical resonators, particularly in the horology field. The invention relates more specifically to a method for manufacturing a set of mechanical resonators, in which a structural characteristic common to these resonators, such as stiffness, is comprised within a predetermined range of values.

### TECHNOLOGICAL BACKGROUND

In the prior art, it is common to use methods for manufacturing mechanical resonators such as horological balance springs in plates, which involve engraving techniques such as laser engraving, plasma engraving, deep reactive ion etching (DRIE) or wet engraving.

However, it has been found that using such methods conventionally results in geometric dissipation between the horological balance springs, all of which are formed in the same pattern on the same plate.

To remedy these drawbacks, solutions have been proposed in the prior art, in particular in patents EP 3181938 and EP 3181939, which describe methods for manufacturing balance springs.

In patent EP 3181938, the manufacturing method comprises the following steps: a) a balance spring is formed in dimensions greater than those required to obtain a balance spring with a predetermined stiffness, b) the stiffness of the balance spring formed in step a) is determined by measuring the frequency of the balance spring coupled with a balance with a predetermined inertia, c) the thickness of material to be removed in order to obtain the balance spring with a predetermined stiffness is calculated, and d) the calculated thickness of material is removed from the balance spring formed in step a), where steps b), c) and d) can be repeated in order to further improve the dimensional quality.

In patent EP 3181939, the manufacturing method comprises the following steps: a) a balance spring is formed in dimensions smaller than those required to obtain a balance spring with a predetermined stiffness, b) the stiffness of the balance spring formed in step a) is determined by measuring the frequency of the balance spring coupled with a balance with a predetermined inertia, c) the thickness of material missing in order to obtain the balance spring with a predetermined stiffness is calculated, and d) the balance spring formed in step a) is modified to compensate for the missing material thickness, where steps b), c) and d) can be repeated in order to further improve the dimensional quality.

Such methods can be improved, particularly in order to limit plate contamination that can occur during the measuring step.

Under these circumstances, there is clearly a need to find solutions that will lead to such an improvement.

### SUMMARY OF THE INVENTION

The present invention aims to provide a method for manufacturing a set of mechanical resonators that meet the above needs.

The invention also aims to improve precision in the manufacture of sets of mechanical resonators having structural characteristics, such as stiffness, with an average value within a predetermined range of values.

The invention relates to a method for manufacturing a set of mechanical resonators having structural characteristics with an average value comprised within a predetermined range of values, said structural characteristic being common to each resonator in said set, the method comprising the following steps:
a) forming in said plate mechanical resonators with dimensions different from the dimensions necessary to obtain the set of mechanical resonators having structural characteristics comprised within said predetermined range of values;
b) forming in said plate at least one oscillating member in an opening made in the plate, said member consisting of a trunk with a body joined at a first end to a securing part of a wall in this opening, and of two flexible arms joined at a second end of said trunk by a connecting part, said arms being parallel to an axis of symmetry of said trunk and extending towards the securing part, said second end having an axial section that is smaller than an axial section of the first end and greater than an axial section of each of the flexible arms;
c) determining a value relative to the structural characteristic of said at least one oscillating member formed;
d) calculating dimensional corrections to be applied to the resonators formed, based on the value determined for the structural characteristic;
e) modifying the dimensions of the resonators formed, based on the dimensional corrections calculated to obtain the set of resonators having structural characteristic values comprised within the predetermined range of values.

In other embodiments:
the step of forming the oscillating member provides for each arm to be designed with a length that can be adjusted according to a resonance measurement tolerance factor that is defined from at least one dimension of a flexible part of the resonator associated with said at least one oscillating member;
the step of forming the oscillating member provides for each arm to be designed at first and second distances, respectively, relative to the trunk body and to the securing part of the wall of the opening, said first distance being greater than said second distance;
said step of forming the oscillating member provides for each arm to be designed with a thickness that is similar or substantially similar to that of a flexible part of each resonator formed in the plate;
said step of forming the oscillating member provides for each arm to be designed with a free end made of the same material as an end member having a mass greater than the mass of the rest of the body of that arm;
the end member has a circular or polygonal cross-section;
said step of forming the oscillating member provides for the trunk body to be designed with the section of the second end that is between three and five times smaller than the section of the first end;
the steps of forming the mechanical resonators and said at least one oscillating member are carried out by engraving, in particular by deep reactive ion etching;
the step of forming each oscillating member is carried out in the plate for at least one resonator in the set of mechanical resonators;
the forming step provides for the creation in the plate of a plurality of oscillating members surrounding at least one resonator;
the determination step comprises a sub-step in which at least one resonance frequency is estimated for each oscillating member associated with at least one resonator in the set of resonators;
the determination step comprises a sub-step in which a structural characteristic is defined for each oscillating member that is of the same nature as the structural characteristic common to each resonator formed, said sub-step being carried out by a processing unit connected to a device for modifying the resonators formed, executing an algorithm for calculating this structural characteristic of each oscillating member based on the estimated resonance frequency;
the calculation step comprises a sub-step in which a thickness of material to be added or removed from at least one dimension of each resonator associated with the oscillating member is determined based on the value determined for the structural characteristic of each oscillating member;
the oscillating member is in the shape of a tuning fork;
the structural characteristic is a stiffness characteristic.

### BRIEF DESCRIPTION OF THE FIGURES

Other features and advantages of the invention will be more clearly apparent from reading the following description of a particular embodiment of the invention, provided merely as an illustrative and non-limiting example, and from the appended figures, among which:

FIG. 1 is a schematic view of a plate comprising a set of mechanical resonators that have all been formed at the same time in this plate, particularly by engraving, according to embodiments of the invention;

FIG. 2A is a larger-scale view of an oscillating member in the form of a tuning fork and enabling a value of a characteristic common to mechanical resonators to be determined, this oscillating member with these resonators being comprised in the plate shown in FIG. 1, according to embodiments of the invention;

FIGS. 2B and 2C are variants of the oscillating member in FIG. 2A, in which the free ends of the arms of this member comprise an end member having a mass greater than the mass of the rest of the body of this arm, according to embodiments of the invention;

FIG. 3 is a schematic view of a section of a flexible part of the resonator manufactured using the method, the section having dimensions necessary to obtain the set of mechanical resonators having structural characteristics with an average value comprised within a predetermined range of values, according to embodiments of the invention;

FIG. 4 is a schematic view of a section of a flexible part of the resonator formed in the plate using the method, the section having dimensions greater than the dimensions of the section of the manufactured resonator illustrated in FIG. 3, according to embodiments of the invention;

FIG. 5 is a schematic view of the section of a flexible part of the resonator formed in the plate using the method, the section having dimensions smaller than the dimensions of the section of the manufactured resonator illustrated in FIG. 3, according to embodiments of the invention, and

FIG. 6 is a flowchart relating to a method for manufacturing a set of mechanical resonators having structural characteristics with an average value comprised within a predetermined range of values, according to embodiments of the invention.

### DETAILED DESCRIPTION OF THE INVENTION

FIG. 6 shows a schematic view of the method for manufacturing a set of mechanical resonators 2a in a plate 1 of material (referred to as a “wafer”). This plate 1 can be a monocrystalline silicon plate, but plates made of other materials can also be used, for example made of polycrystalline or amorphous silicon, of other semiconductor materials, of glass, of ceramics, of carbon, of quartz, of metal or alloy, or of a composite comprising these materials. However, monocrystalline silicon is relatively insensitive to magnetic fields and belongs to the cubic crystal class, which has an isotropic thermal expansion coefficient (alpha).

In this method, the mechanical resonator 2a, 2b, 2c is an elastically distortable component that can be driven by oscillating movements. In other words, this resonator 2a, 2b, 2c comprises a body consisting of a flexible part 3 and of a connecting part that is stiff relative to this flexible part 3, said connecting part enabling this resonator 2a, 2b, 2c to be secured to an axis or to an arbor. Such a mechanical resonator 2a, 2b, 2c can be used in a watch, particularly in a mechanical regulator regulating a mechanical watch movement. In the watch, the oscillations of such a resonator determine the rate of the movement. Many watches comprise, for example, a regulator comprising a balance spring as a resonator, mounted on the axis of a balance and set in oscillation by an escapement. The natural frequency of the sprung balance regulates the watch. Such a horological balance spring comprises an elastically flexible strand connected at one end to the collet and wound in a spiral so as to form several consecutive turns, the last of which is extended by an attachment segment designed to be attached to a fixed balance bar, for example by means of a balance spring stud. Such a collet is designed to be secured to a pivoting arbor. Other known types of resonators are based, for example, on oscillating bars or other mechanical members.

This method therefore makes it possible to manufacture this set of resonators 2a having structural characteristics with an average value comprised within a predetermined range of values. In this method, this characteristic is common to all resonators 2a in this set. In other words, these resonators have the same structural characteristic. This structural characteristic can be a stiffness characteristic of this resonator 2a and in particular of its flexible part 3. In this case, the method enables this particular set of resonators 2a to be selected from among a plurality of resonators formed in this plate 1. To do so, this method therefore helps to create a map indicating the geometric dispersion between the dimensions of the resonators formed in the plate, and thereby the dispersion between their common structural characteristics, and by making a correction to the selected set of resonators so that they have structural characteristics having an average value comprised within the predetermined range of values. Such a method aims to ensure very high dimensional precision of the manufactured resonators 2a and, incidentally, to guarantee a more precise structural characteristic of these resonators 2a.

It should be noted that in a preferred embodiment of this method, the resonator 2a, 2b, 2c can be a horological balance spring and the structural characteristic can be the stiffness of this spring, in particular of its blade. In this case, this method can then be a method for manufacturing a set or an assembly of horological balance springs 2a in the plate 1, where the stiffnesses have an average value comprised within a predetermined range.

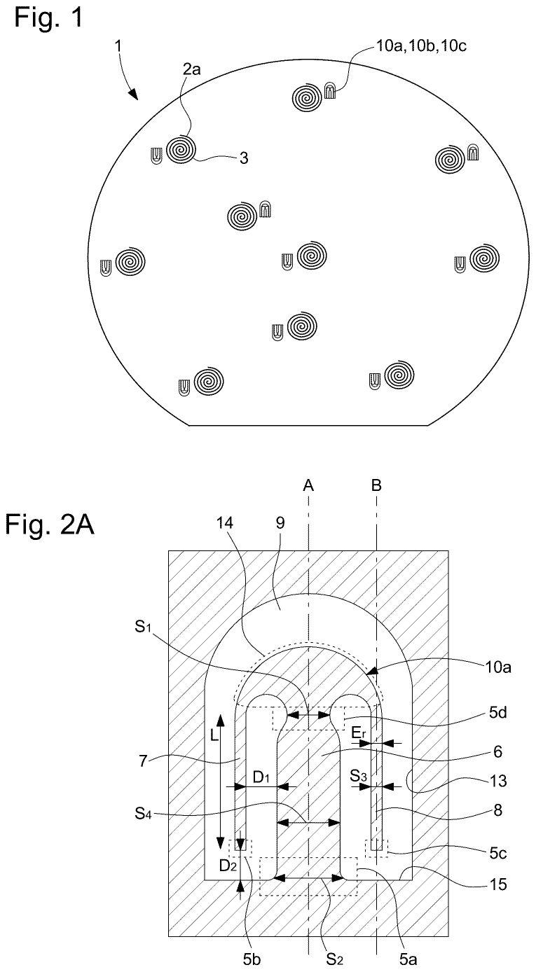

Referring to FIG. 1, a set of mechanical resonators 2b, 2c is formed in the plate 1 of material. In this set, each resonator 2b, 2c therefore comprises a flexible part 3 comprising a stiff connecting part for securing this resonator to an axis or to an arbor.

In the context in which this resonator 2b, 2c is a balance spring, the latter comprises a collet for securing it to a pivoting arbor.

Such a method is used in a system for manufacturing the set of resonators 2a, 2b, 2c in the plate 1. This system comprises, but is not exhaustive or limited to: a processing unit such as a computer, a device for forming resonators 2b, 2c and at least one oscillating member 10a, 10b, 10c in the plate 1, and a device for modifying the resonators 2b, 2c formed in this plate 1.

The device for forming resonators 2b, 2c and oscillating members 10a, 10b, 10c can be used to implement microfabrication technologies such as photolithography, machining and engraving methods in the plate 1. In particular, methods such as deep reactive ion etching, laser engraving, chemical engraving or engraving using a focused ion beam.

The device for modifying resonators 2b, 2c comprises a module for determining structural characteristics and a module for dimensional correction of the resonators 2b, 2c. This module for determining structural characteristics comprises:
A sub-module for driving/releasing a mechanical oscillating movement in the body of an oscillating member 10a, 10b, 10c around its stable equilibrium position;
A sub-module for measuring a resonance frequency of the oscillating member 10a, 10b, 10c in a mechanical oscillating movement.

With regard to the dimensional correction module for resonators 2b, 2c, it comprises a sub-module for calculating a correction to be made to resonators 2b, 2c and a sub-module for correcting these resonators 2b, 2c, which uses oxidation and then deoxidation technologies on these resonators, thermal oxidation, galvanic growth, physical vapour phase deposition, chemical vapour phase deposition, atomic layer deposition or any other additive process.

In this system, this processing unit is connected to these devices for forming resonators 2b, 2c and at least one oscillating member 10a, 10b, 10c in the plate 1, and for modifying the resonators 2b, 2c formed. Such a processing unit comprises at least a processor and memory elements. This unit is capable of executing instructions for the implementation of a computer programme intended, for example, to guide/control these two devices. In particular, such a unit can ensure the guidance/control of the drive and measuring sub-modules, as well as the calculation/processing operations in which at least one algorithm stored in the memory elements is implemented. This algorithm can comprise a machine learning algorithm and/or mathematical formulas. This algorithm is capable of using a predictive model or a simulation model to determine the structural characteristics, in particular the stiffness, of at least one oscillating member 10a, 10b, 10c and of the dimensional corrections to be made to the resonators 2b, 2c formed in the plate 1.

Such a method comprises a step 20 in which mechanical resonators 2b, 2c are formed in the plate 1 according to dimensions E2, E3, H2, H3 that differ from the dimensions E1, H1 required to obtain the set of mechanical resonators 2a having structural characteristics with an average value comprised within a predetermined range of values.

In this step 20, the resonators 2b, 2c are formed in the plate 1. These resonators 2b, 2c are preferably formed simultaneously in this plate 1. The formation of these resonators 2b, 2c in the plate 1 is carried out by the forming device controlled by the processing unit of the system. It should be noted that these resonators 2b, 2c preferably have similar geometries or form similar patterns.

Referring to FIGS. 1, 4 and 5, these mechanical resonators 2b, 2c formed in this plate 1 have a flexible part 3 having sections 4b, 4c with dimensions E2, H2, E3, H3. The sections 4b, 4c of this flexible part 3 preferably have a polygonal shape similar to the blade of a balance spring and are characterised by a height H1, H2, H3 and a thickness E1, E2, E3 of this section 4a, 4b, 4c—which are different from the dimensions E1, H1 required to obtain the set of mechanical resonators 2a having structural characteristics with an average value comprised within the predetermined range. In other words, the flexible part 3 of each resonator 2b, 2c can have a section 4b, 4c with dimensions E2, H2, E3, H3 that are greater than or smaller than the necessary dimensions E1, H1 for the section 4a of this flexible part of the manufactured resonator 2a that makes it possible to obtain a structural characteristic with an average value comprised within the predetermined range.

As previously mentioned, this plate 1 is preferably made of doped or undoped silicon. This silicon can be monocrystalline, polycrystalline or amorphous silicon. Furthermore, this silicon can have a direction of {1,1,1}, {−1,1,1}, {1, −1,1}, {−1, −1,1}, for which Young's model of the silicon is most important.

It should be noted that during this formation step 20, the mechanical resonators 2b, 2c formed can have:
dimensions E2, H2 greater than dimensions E1, H1 necessary to obtain the set of mechanical resonators 2a having structural characteristics, such as stiffness, with an average value comprised within the predetermined range of values, namely a height H2 of the flexible part 3 and/or a thickness E2 of the flexible part 3 greater than the height H1 and/or the thickness E1 of the flexible part 3 of the mechanical resonators 2a having structural characteristics, such as stiffness, with an average value comprised within the predetermined range;
dimensions E3, H3 smaller than dimensions E1, H1 necessary to obtain the set of mechanical resonators 2a having structural characteristics, such as stiffness, with an average value comprised within the predetermined range, namely a height H3 of the flexible part 3 and/or a thickness E3 of the flexible part 3 smaller than the height H1 and/or the thickness E1 of the flexible part 3 of the mechanical resonators 2a having structural characteristics, such as stiffness, with an average value comprised within the predetermined range.

The method also comprises a step 21 in which at least one oscillating member 10a, 10b, 10c is formed in the plate 1, said oscillating member comprising a trunk 6 and flexible arms/branches 7, 8, said arms 7, 8 being parallel to an axis of symmetry A of said trunk 6.

This step 21 is carried out in the same plate 1 comprising the mechanical resonators 2b, 2c formed, preferably simultaneously with the step 20 in which these resonators 2b, 2c are formed.

In this step 21, at least one oscillating member 10a, 10b, 10c is produced in the plate 1 for at least one resonator 2b, 2c in the set of mechanical resonators 2b, 2c. For example, an oscillating member 10a, 10b, 10c can be produced for several resonators 2b, 2c arranged in its immediate vicinity or for each resonator 2b, 2c. Alternatively, several oscillating members 10a, 10b, 10c can be arranged in the plate 1 around a single resonator 2b, 2c and in particular in the immediate vicinity of this resonator 2b, 2c.

In this step 21, this member 10a, 10b, 10c is designed in an opening 9 provided in this plate 1. Such an opening 9 is a through hole made in the thickness of the plate 1, which comprises a peripheral wall 13. Such an opening 9 defines a space in which the oscillating member 10a, 10b, 10c can freely perform a guided/controlled mechanical oscillating movement.

As mentioned above, this oscillating member 10a, 10b, 10c consists of a trunk/arbor 6 with a preferably rectilinear body joined at one end 5a, also referred to as the attachment end 5a, to the peripheral wall 13 of this opening 9 and in particular to a securing part 15 of this wall 13. This trunk body 6 also comprises a second end 5d having an axial section S1 that is smaller than an axial cross-section S2 of the first end 5a. The body of this trunk has an axial section S4 that is essentially constant between its first and second ends 5a and 5d. It should be noted that this section S1 of the second end 5d is preferably between three and five times smaller than the section S2 of the first end 5a. This difference in sections makes it possible to decrease the stiffness of the trunk body 6 at this second end 5d and to create a difference between the modes in which the arms 7, 8 are in phase and in antiphase when measuring the structural characteristic of the oscillating member 10a, 10b, 10c, which is used in a step 22 for determining a relative value of this structural characteristic, which will be described hereinafter. It should be noted that the in-phase mode corresponds to the mode in which the arms oscillate in the same direction at the same time. In the antiphase mode, the arms oscillate with a phase shift of 180 degrees. Both arms move in and out at the same time.

Moreover, it should be noted that the difference in sections increases the stiffness of the trunk body 6 at the first end 5a in order to decouple the oscillating movement of the arms 7, 8 of the plate 1 when this measurement is taken.

The body of this trunk 6 is preferably stiff relative to the flexible arms 7, 8 comprised in this trunk 6. More specifically, the body of this trunk 6 is joined to these flexible arms 7, 8 at its second end 5d by means of a connecting part 14. These two arms 7, 8 extend rectilinearly in this opening 9, parallel to the axis of symmetry A and towards the securing part 15. It should be noted that these arms 7, 8 can each have a thickness similar or substantially similar to that of the flexible part 3 of the resonator 2a, 2b.

These two arms 7, 8 have axial sections S3 that are similar. Each axial section S3 is defined relative to the axis of symmetry B of each arm 7, 8, which is parallel to the axis of symmetry A of the trunk body 6. In this configuration, the first and second axial sections S1, S2 of the trunk body 6 are greater than the axial section S3 of each arm 7, 8.

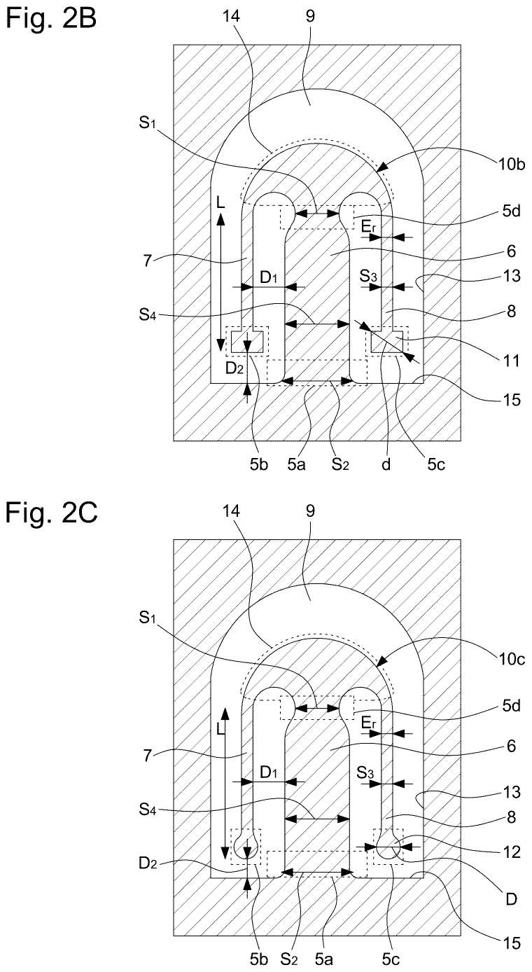

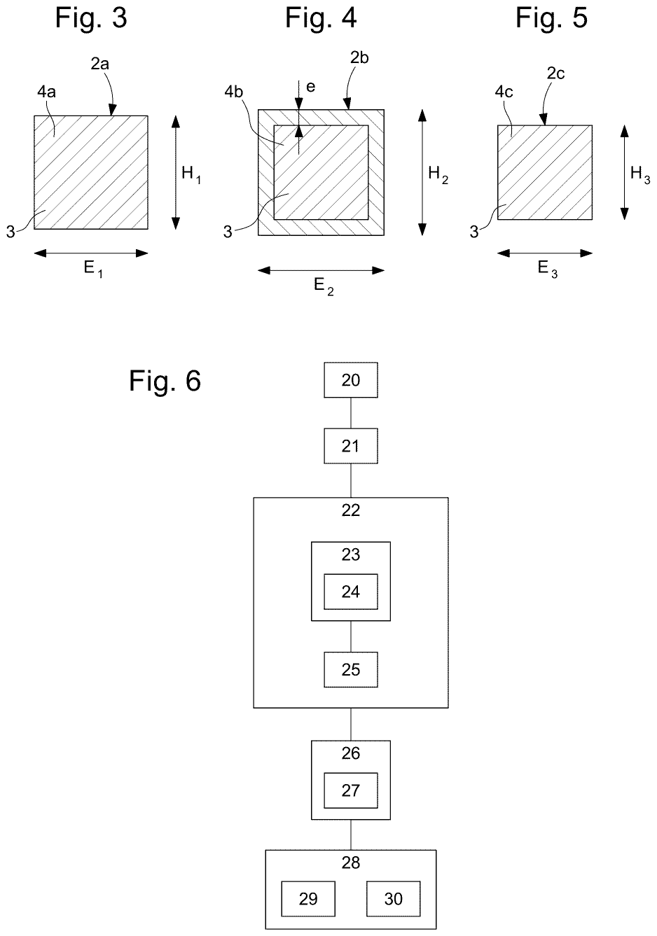

Referring to FIGS. 6 and 2A to 2B, in this step 21, these arms 7, 8 are designed at:
a first distance D1 from the body of the trunk 6 of this oscillating member 10a, 10b, 10b, which is preferably greater or substantially greater than or substantially similar to the inter-turn distance of the resonator 2b, 2c when it is a spring or a balance spring, and
a second distance D2 from the securing part 15 of the wall 13 of the opening 9.

In this configuration, the first distance D1 is greater than the second distance D2.

It should be noted that these arms 7, 8 are designed with a thickness Er which is preferably similar or substantially similar to the thickness E2, E3 of the flexible part 3 of each resonator 2b, 2c formed in the plate 1. In other words, when this flexible part 3 is the blade of the balance spring, the thickness Er of each arm 7, 8 is then similar or substantially similar to the thickness E2, E3 of this flexible part 3. For example, these arms 7, 8 can have a thickness Er comprised between 10 and 60 μm, preferably 30 μm.

In this step 21, these arms 7, 8 are drawn with a length L that can be adjusted according to the desired resonance measuring tolerance. This tolerance is defined based on at least one variation in the dimensions E2, E3, H2, H3 of the flexible part 3 of the resonator 2b, 2c associated with this oscillating member 10a, 10b, 10c. This tolerance has a value equal to a desired frequency interval enabling a dimensional variation E2, E3, H2, H3 to be measured on the resonator 2b, 2c, resulting in a difference in stiffness of this resonator that no longer requires correction. This value then defines a measuring interval in which fine/sensitive dimensional variations of the flexible part 3 of the resonator 2b, 2c formed are no longer necessarily determined. In other words, no adjustment is necessary below this tolerance. This value is specifically adapted to the dimensions of this flexible part 3 of the resonator 2b, 2c, so as to improve the sensitivity of the measurements and of the variations in engraving thickness. As an example, the length will be calculated such that a variation of 10 Hz in the oscillating member enables a 10 nm dimensional variation E2, E3 of the resonator to be measured.

In this step, the process of calculating the length of the oscillating member 10a, 10b, 10c comprises:
defining a dimension Er that is preferably similar or substantially similar to the thickness E2, E3, H2, H3 of the flexible part 3 of each resonator 2b, 2c formed in the

plate 1;
defining a frequency variation that can be measured by the measuring system, allowing for precise measurement of the frequency, between 2 and 10 times the standard deviation of the measurement;
defining the minimum dimensional variation of E2, E3, H2, H3 of the resonator 2b, 2c that is to be measured;
calculating a length L of the arms 7, 8 comprised between 1 mm and 2 mm, such that measuring the frequency variation makes it possible to draw conclusions about the dimensional variation of E2, E3, H2, H3 of the resonator 2b, 2c.

It should be noted that the shorter the length L of the arms 7, 8, the higher the measured resonance frequency will be, and the more sensitive the ratio between the addition or removal of a uniform thickness of material on the oscillating member 10a, 10b, 10c and its resonance frequency will be.

In this step 21, it should be noted that the oscillating member 10a, 10b, 10c is preferably arranged in this plate 1 such that its arms 7, 8 are positioned so that the Young's modulus is at its maximum or minimum, particularly if this plate 1 is made of silicon. Indeed, since silicon is anisotropic, this arrangement makes it possible to avoid significant variability in the Young's modulus depending on the angle used to determine structural characteristics such as stiffness. Moreover, the maximum Young's modulus should be prioritised to increase the precision of the correlation between stiffness and the measured frequency.

In variants illustrated in FIGS. 2B and 2C, the step 21 in which the oscillating member 10a, 10b is formed 10c provides that each arm 7, 8 is designed with a free end 5b, 5c made of material with an end member 11 having a mass greater than the mass of the rest of the body of this arm 7, 8. In FIG. 2B, the end member 11 has a polygonal transverse section and in FIG. 2C, this section of the end member 12 is circular. This end member 11, makes it possible to reduce the resonance frequency of the arms 7, 8 while maintaining good sensitivity between the engraving thickness Er and this frequency. In this case, the process for calculating the length of the oscillating member 10a, 10b, 10c comprises:
defining a dimension Er that is preferably similar or substantially similar to the thickness E2, E3, H2, H3 of the flexible part 3 of each resonator 2b, 2c formed in the plate 1;
defining a frequency variation that can be measured by the measuring system, allowing for precise measurement of the frequency, between 2 and 10 times the standard deviation of the measurement; this frequency variation can be 10 Hz, for example;
defining the minimum dimensional variation of E2, E3, H2, H3 of the resonator 2b, 2c to be measured; this variation can be, for example, 10 nm for a measurable frequency variation of 10 Hz;
calculating a length L of the arms 7, 8 comprised between 1 mm and 2 mm, such that measuring the frequency variation makes it possible to draw conclusions about the dimensional variation of E2, E3, H2, H3 of the resonator 2b, 2c;
calculating the dimensions of the arm ends in order to reduce the measuring frequency to a range that is reasonable for the measuring system.

Advantageously, these end members 11, 12 provide a greater surface area than that of the arms 7, 8, which makes it easier to measure the resonance frequency of this oscillating member 10b, 10c.

It is understood that the oscillating member 10a, 10b, 10c designed during this formation step 21 has the general shape of a tuning fork or is a tuning fork.

This oscillating member 10a, 10b, 10c allows for optimum decoupling of the setting effect on resonance frequencies. Indeed, during harmonic excitation, the setting has a significant effect on the resonance frequency. In the case of this oscillating member 10a, 10b, 10c, there is a significant decoupling between this setting and the resonance frequency of the arms 7, 8. The correlation between the resonance frequency and the structural characteristic, such as stiffness, becomes unrelated to the quality of the engraving of the setting.

Moreover, such an oscillating member 10a, 10b, 10c is configured such that the structural characteristic can be easily determined from the module for determining structural characteristics in the resonator modification device. It should be noted that such an oscillating member 10a, 10b, 10c is configured to vibrate at a stable frequency despite changes in certain parameters relating in particular to the setting and to the manufacturing process. This stable frequency varies according to one or more parameters/structural characteristics of this oscillating member 10a, 10b, 10c. In the present embodiment, the structural characteristic of the oscillating member 10a, 10b, 10c that significantly varies the resonance frequency is preferably the thickness of the arms Er. Other characteristics besides the thickness Er of the arms can be used, such as stiffness and arm height h. In the actual process, a frequency is measured and a dimension is derived therefrom under the engraving mask (arm thickness=value of the arms on the DRIE mask−dimension under the engraving). The stiffness of the tuning fork is not directly obtained. Then, once this thickness (dimension under the engraving mask) has been deducted, the stiffness of the balance spring is calculated so that the necessary adjustments can be made.

The method then comprises a step 22 in which the structural characteristic of the at least one oscillating member 10a, 10b, 10c associated with at least one resonator 2b, 2c formed in the plate 1 is determined. This step 22 comprises a sub-step 23 in which at least one resonance frequency of the at least one oscillating member 10a, 10b, 10c is estimated. In this sub-step 23, said at least one oscillating member 10 a, 10 b, 10 c is set in a mechanical oscillating movement around its stable equilibrium position. During this movement, the resonance frequency of this oscillating member 10a, 10b, 10c is then determined in a measuring phase 24.

This measuring phase 24 is embodied by the measuring sub-module of the module for determining structural characteristics in the resonator modification device 2b, 2c. In the variants of the oscillating member 10b, 10c provided with the arms 7, 8 each comprising the end member 11, 12, the measuring sub-module comprises a velocimeter that can be focused on these end members 11, 12 of these arms 7, 8 making oscillating movements. In this configuration, the measurement can be taken outside of the plane, with the velocimeter axis orthogonal to the wafer plane.

It should be noted that when several oscillating members 10a, 10b, 10c are associated with a single resonator 2a, 2c, the resonance frequencies of all these oscillating members 10a, 10b, 10c are measured and an average of these frequencies is then calculated to correspond to the resonance frequency relating to this combination of oscillating members 10a, 10b, 10c. Alternatively, the measured resonance frequency of this combination can be a resonance frequency of only one of its oscillating members 10a, 10b, 10c or a resonance frequency of a sample of its oscillating members 10a, 10b, 10c.

Once the resonance frequency has been estimated, this step 22 comprises a sub-step 25 in which the structural characteristic, such as the stiffness of the at least one oscillating member 10a, 10b, 10c, is defined. In this sub-step 25, the processing unit executes the algorithm for calculating this structural characteristic from the estimated resonance frequency of the at least one oscillating member 10a, 10b, 10c.

The method then comprises a step 26 in which a dimensional correction is calculated to be applied to each resonator 2b, 2c in the set of mechanical resonators based on the structural characteristic determined for the associated system 3. In this step 26, a quantification of the dimensional correction to be applied to the resonator 2b, 2c is then determined.

To do so, this step 26 comprises a sub-step 27 in which, based on the structural characteristic determined, a thickness e of material to be added to or removed from at least one dimension of the resonator 2b, 2c is determined for the set of mechanical resonators formed in the formation step 20 to obtain the set of mechanical resonators 2a having structural characteristics with an average value comprised within the predetermined range of values.

This dimensional correction effectively corresponds to a thickness e of material to be removed or added to the resonator 2b, 2c so as to vary at least one of its dimensions E2, H2, E3, H3, namely:
only the height H2, H3 of the flexible part 3, or
only the thickness E2, E3 of the flexible part 3, or
both this height H2, H3 and this thickness E2, E3.

This dimensional correction can be made on one or more separate lengths of the flexible part 3 or over the entire length of the flexible part 3 of this resonator 2b, 2c.

Such a sub-step 27 thus makes it possible, by determining the dimensional correction, to participate in shaping a geometry for this resonator 2b, 2c that will give it a value for the structural characteristic that will be comprised within the predetermined value range.

The method then comprises a step 28 in which the dimensions E2, E3, H2, H3 of the mechanical resonators 2b, 2c are modified based on a calculated dimensional correction in order to obtain the set of mechanical resonators 2a having structural characteristics with an average value comprised within the predetermined range of values.

In this case, if the dimensions E2, H2 of the resonators 2b are greater than the dimensions E1, H1 necessary to obtain the set of mechanical resonators 2a having structural characteristics with an average value comprised within the predetermined range of values, this step 28 then comprises a sub-step 29 in which material is removed according to the calculated thickness e of the material to be removed. This removal can then be carried out using a process of oxidation followed by deoxidation of these resonators 2b, which is well known in the prior art. Such a sub-step 29 aims to reduce the dimensions of the section 4b of the flexible part 3 of this resonator 2b over a given length or over the entire length of this flexible part 3.

If the dimensions E3, H3 of the resonators 2c are smaller than the dimensions E1, H1 necessary to obtain the set of mechanical resonators 2a having structural characteristics with an average value comprised within the predetermined range, this step 28 then comprises a sub-step 30 in which material is added according to the calculated thickness e of the material to be added. This material can then be added using methods known in the prior art, such as thermal oxidation, galvanic growth, physical vapour phase deposition, chemical vapour phase deposition, atomic layer deposition or any other additive process. Such a sub-step 30 aims to increase the dimensions E3, H3 of the section 4c of the flexible part 3 of this resonator 2c over a given length or over the entire length of this flexible part 3.

Such a method therefore makes it possible to correct, with high precision provided by said reference stiffness indication systems, dimensional errors in resonators manufactured using such methods involving photolithography and/or DRIE technologies.

### Terminology

1. Plate comprising at least one resonator
2a. Manufactured mechanical resonator
2b. Mechanical resonator formed in the plate with a section with dimensions greater than those of the section of the manufactured resonator
2c. Resonator formed in the plate with a section with dimensions smaller than those of the section of the manufactured resonator
3. Flexible part of the mechanical resonator
4a. Section of the manufactured resonator
4b. Section of the resonator formed with dimensions greater than those of the section of the manufactured resonator
4c. Section of the resonator formed with dimensions smaller than those of the section of the manufactured resonator
5a. Attachment end of the oscillating member
5b, 5c. Free end of the oscillating member
6. Arbor/trunk of the oscillating member
7. First flexible arm on the oscillating member
8. Second flexible arm on the oscillating member
9. Opening in which the oscillating member is arranged
10. Oscillating member
11. End member of a polygonal section
12. End member of a circular section
13. Peripheral wall of the opening
14. Part connecting the arms to the trunk of the oscillating member
15. Securing part in the wall of the opening of the oscillating member

1. A method for manufacturing a set of mechanical resonators having structural characteristics with an average value comprised within a predetermined range of values, said structural characteristic being common to each resonator in said set, the method comprising the following steps:
a) forming in said plate mechanical resonators with dimensions different from the dimensions necessary to obtain the set of mechanical resonators having structural characteristics comprised within said predetermined range of values;
b) forming in said plate at least one oscillating member in an opening made in the plate, said member consisting of a trunk with a body joined at a first end to a securing part of a wall in this opening, and of two flexible arms joined at a second end of said trunk by a connecting part, said arms being parallel to an axis of symmetry of said trunk and extending towards the securing part, said second end having an axial section that is smaller than an axial section of the first end and greater than an axial section of each of the flexible arms;
c) determining a value relative to the structural characteristic of said at least one oscillating member formed;
d) calculating dimensional corrections to be applied to the resonators formed, based on the value determined for the structural characteristic;
e) modifying the dimensions of the resonators formed, based on the dimensional corrections calculated to obtain the set of resonators having structural characteristic values comprised within the predetermined range of values.

2. The method according to claim 1, wherein said step of forming the oscillating member provides for each arm to be designed with a length that can be adjusted according to a resonance measurement tolerance factor that is defined from at least one dimension of a flexible part of the resonator associated with said at least one oscillating member.

3. The method according to claim 1, wherein said step of forming the oscillating member provides for each arm to be designed at first and second distances, respectively, relative to the trunk body and to the securing part of the wall of the opening, said first distance being greater than said second distance.

4. The method according to claim 1, wherein said step of forming the oscillating member provides for each arm to be designed with a thickness that is similar or substantially similar to that of a flexible part of each resonator formed in the plate.

5. The method according to claim 1, wherein said step of forming the oscillating member provides for each arm to be designed with a free end made of the same material as an end member having a mass greater than the mass of the rest of the body of that arm.

6. The method according to claim 1, wherein said step of forming the oscillating member provides for each arm to be designed with a free end made of the same material as an end member having a mass greater than the mass of the rest of the body of that arm, this end member having a circular or polygonal cross-section.

7. The method according to claim 1, wherein said step of forming the oscillating member provides for the trunk body to be designed with the section of the second end that is between three and five times smaller than the section of the first end.

8. The method according to claim 1, wherein the steps of forming the mechanical resonators and said at least one oscillating member are carried out by engraving, in particular by deep reactive ion etching.

9. The method according to claim 1, wherein in the step of forming each oscillating member is carried out in the plate for at least one resonator in the set of mechanical resonators.

10. The method according to claim 1, wherein the forming step provides for the creation in the plate of a plurality of oscillating members surrounding at least one resonator.

11. The method according to claim 1, wherein the determination step comprises a sub-step wherein at least one resonance frequency is estimated for each oscillating member associated with at least one resonator in the set of resonators.

12. The method according to claim 1, wherein the determination step comprises a sub-step wherein a structural characteristic is defined for each oscillating member that is of the same nature as the structural characteristic common to each resonator formed, said sub-step being carried out by a processing unit connected to a device for modifying the resonators formed, executing an algorithm for calculating this structural characteristic of each oscillating member based on the estimated resonance frequency.

13. The method according to claim 1, wherein the calculation step comprises a sub-step wherein a thickness of material to be added or removed from at least one dimension of each resonator associated with the oscillating member is determined based on the value determined for the structural characteristic of each oscillating member.

14. The method according to claim 1, wherein the oscillating member is in the shape of a tuning fork.

15. The method according to claim 1, wherein the structural characteristic is a stiffness characteristic.
